(19) United States
(12) Patent Application Publication
(10) Pub. No.: US 2011/0298665 A1
(43) Pub. Date: Dec. 8, 2011

(54) Array antenna device

(75) Inventor: Huei Chi Wu, Tauyuan Hsien (TW)

(73) Assignee: Joymax Electronics Co., Ltd.

(21) Appl. No.: 12/802,488

(22) Filed: Jun. 7, 2010

(51) Int. Cl. H01Q 9/04

(52) U.S. Cl. 343/700 MS

(57) ABSTRACT

An array antenna device includes a substrate, an antenna member having a number of antenna elements and having a number of connecting lines connected between the antenna elements for forming an integral structure, and a number of connecting elements coupling and securing the antenna member to the substrate for forming a spacing gap between the antenna member and the substrate, and for allowing the antenna member to be easily and quickly attached or secured to the substrate and to be easily and quickly assembled and manufactured by the workers and for allowing the manufacturing cost for the array antenna device to be suitably decreased.

### BACKGROUND OF THE INVENTION

1. Field of the Invention

The present invention relates to an array antenna device, and more particularly to an array antenna device including a number of antenna members arranged to be easily and quickly attached or mounted or secured to the supporting base board and arranged for allowing the array antenna device to be easily and quickly assembled and manufactured by the workers and for decreasing the manufacturing cost for the array antenna device.

2. Description of the Prior Art

Typical array antenna devices comprise an antenna array including a number of antenna members or radiator elements applied or printed or disposed on a polyethylene foam substrate for forming a circuit module, and including phase shifting elements for the purposes of electronically steering the antenna transmit/receive beam.

For example, U.S. Pat. No. 4,937,585 to Shoemaker discloses one of the typical microwave circuit modules or antenna devices comprising a polyethylene foam substrate, a predetermined pattern of one or more elements, such as an array of n×m radiator elements, formed of electrically conductive materials, disposed on a first surface of the substrate, and an electrically conductive ground plane secured to the opposite surface of the substrate for forming the circuit module or antenna device.

However, it will be difficult and complicated to attach or mount the radiator elements onto the polyethylene foam substrate, when the radiator elements are formed and manufactured separately from the polyethylene foam substrate, by the workers with the adhesive materials, latches or fasteners, or by welding processes or the like, such that the manufacturing cost for the array antenna device will be greatly increased.

U.S. Pat. No. 5,021,795 to Masiulis discloses another typical passive temperature compensation scheme for microstrip antennas and used to compensate for changes in the resonant frequency of a microstrip patch antenna array structure due to dielectric constant thermal effects.

However, it will be difficult and complicated to attach or mount the elements or members onto the substrate by the workers with the adhesive materials, latches or fasteners, or by welding processes or the like, such that the manufacturing cost for the array antenna device will be greatly increased.

U.S. Pat. No. 5,563,613 to Schroeder et al. discloses d further typical planar, phased array antenna comprising a ground plate, a signal plate having a plurality of hollow active elements and conductive branches electrically connecting the active elements in mirror symmetrical pairs.

However, it will be difficult and complicated to attach or mount the active elements or conductive branches or members onto the substrate by the workers with the adhesive materials, latches or fasteners, or by welding processes or the like, such that the manufacturing cost for the array antenna device will be greatly increased.

The present invention has arisen to mitigate and/or obviate the afore-described disadvantages of the conventional multi-transceiver array antenna devices.

### SUMMARY OF THE INVENTION

The primary objective of the present invention is to provide an array antenna device including a number of antenna members arranged to be easily and quickly attached or mounted or secured to the supporting base board and arranged for allowing the array antenna device to be easily and quickly assembled by the workers and manufactured and for decreasing the manufacturing cost for the array antenna device.

In accordance with one aspect of the invention, there is provided an array antenna device comprising a substrate, an antenna member including a number of antenna elements, and including a number of connecting lines connected between the antenna elements for forming an integral structure, and a number of connecting elements coupling and securing the antenna member to the substrate, for forming a spacing gap between the antenna member and the substrate, and for allowing the antenna member to be easily and quickly attached or secured to the substrate and to be easily and quickly assembled and manufactured by the workers and for allowing the manufacturing cost for the array antenna device to be suitably decreased.

The substrate includes a number of compartments formed therein and aligned with the antenna elements of the antenna member. The substrate includes a number of casings having the compartments formed in the casings.

The antenna member includes a feed connected to a feed wire, and the feed wire is coupled to the substrate. The connecting elements may be made of electrically conductive materials, or alternatively, may be made of dielectric materials.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of an array antenna device in accordance with the present invention;

FIG. 2 is a perspective view of the array antenna device;

FIG. 3 is another perspective view of the array antenna device, in which a portion of the array antenna device has been cut off for showing the inner structure of the array antenna device; and

FIG. 4 is a side plan schematic view of the array antenna device.

### DETAILED DESCRIPTION OF THE PREFERRED EMBODIMENT

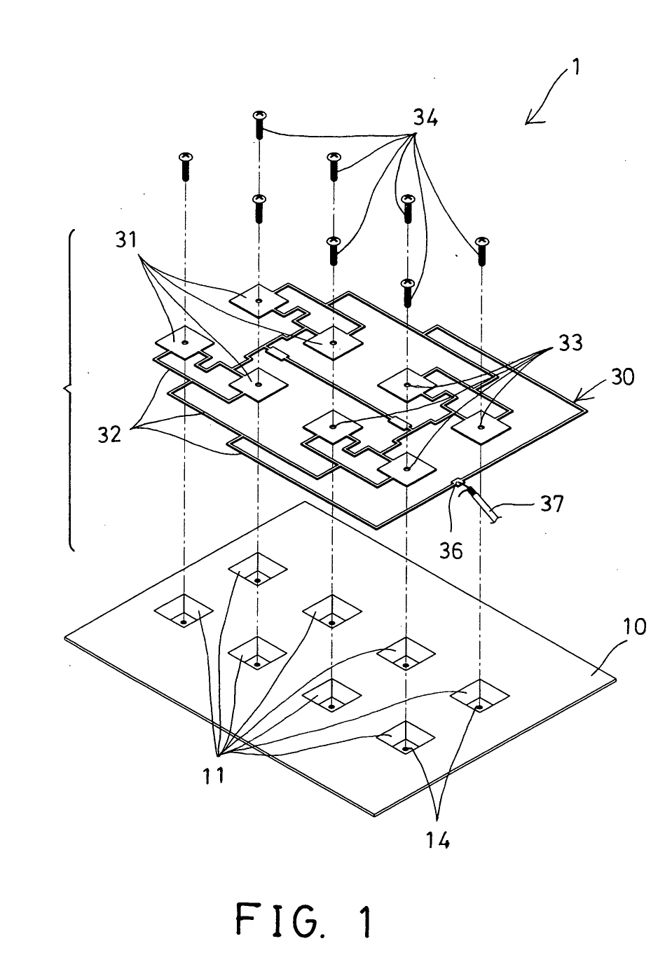

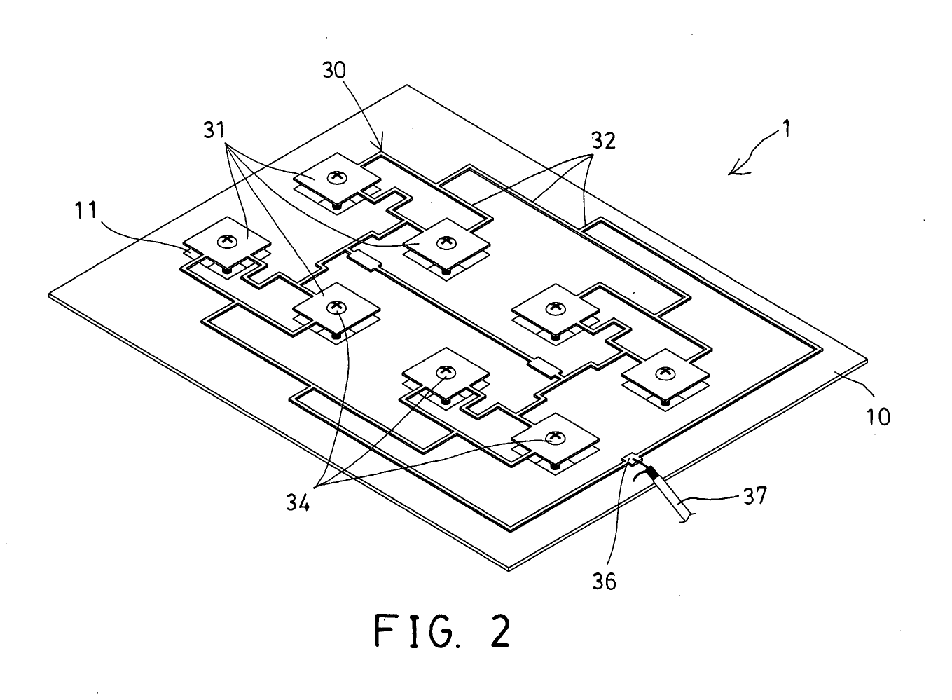

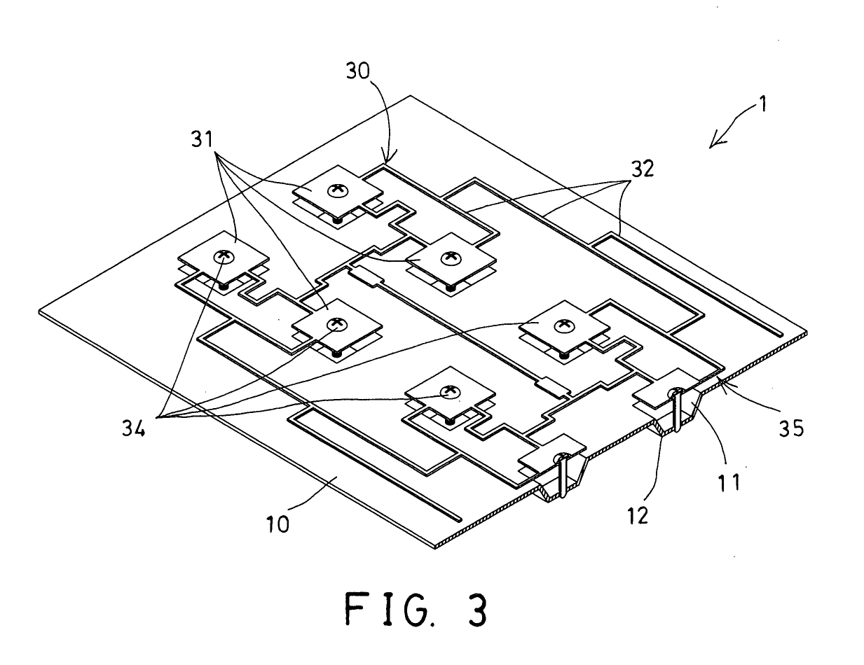

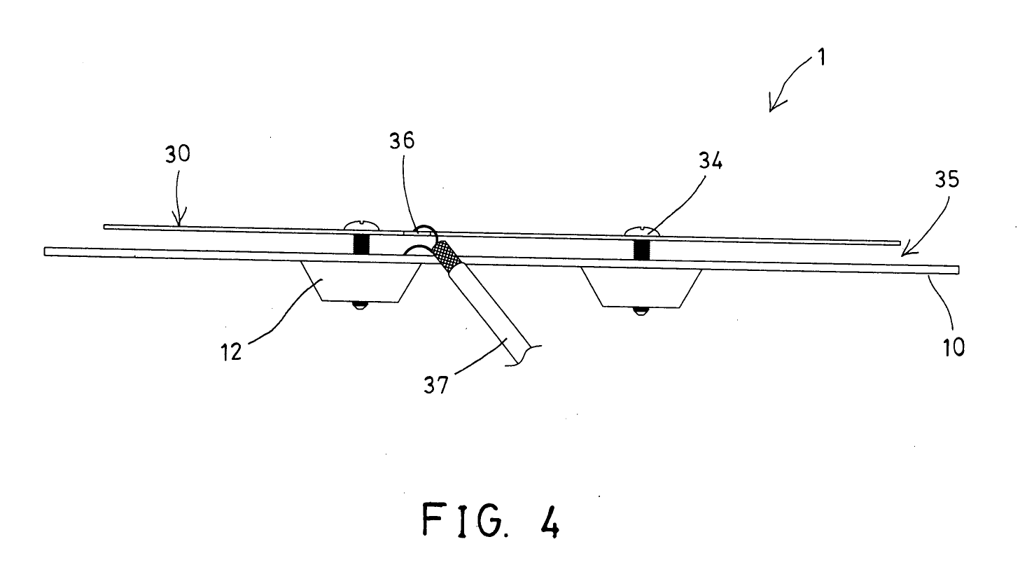

Referring to the drawings, and initially to FIGS. 1, 2 and 3, an array antenna device 1 in accordance with the present invention comprises a support base or ground plate or polyethylene foam substrate 10 or the like including a number of cavities or compartments 11 formed therein and each formed or defined a downwardly extended casing 12 (FIGS. 3, 4), and including an engaging or securing hole or screw hole 14 formed in each of the casings 12 and communicative with the respective compartments 11 of the substrate 10.

The array antenna device 1 further comprises an antenna body or member 30 including a number of antenna elements 31 disposed or arranged in lines, in matrix or in an array structure, and including a number of coupling or connecting members or lines 32 electrically coupled or connected between the antenna elements 31 for forming an integral structure for the antenna member 30, best shown in FIGS. 1-3, and including an engaging or securing hole or screw hole 33 formed in each of the antenna elements 31.

A number of fasteners or spacing or connecting elements 34 are threaded or engaged with the holes 33, 14 of the antenna member 30 and the substrate 10 for attaching or mounting or securing or coupling the antenna member 30 to the substrate 10 and for suitably spacing the antenna member 30 from the substrate 10 for a predetermined spacing distance or gap 35, or for forming a predetermined spacing distance or gap 35 between the antenna member 30 and the substrate 10, the connecting elements 34 may be selected from the electrically conductive materials, such as bolts or screws, copper stems, or the like, and may also be selected from the dielectric materials, such as rubber or plastic shanks or posts.

The antenna member 30 includes a terminal or feed 36 for electrically coupling or connecting to a feed line or wire 37 which is also electrically coupled or connected to the substrate 10 for signal receiving or emitting purposes. It is to be noted that the antenna elements 31 may be arranged in lines, in matrix or in an array structure, and may be electrically coupled or connected together with the connecting lines 32 in order to form the integral structure, and for allowing the antenna elements 31 of the antenna member 30 to be easily and quickly attached or mounted or secured to the substrate 10 with the connecting elements 34.

In operation or while assembling, as shown in the drawing figures, the antenna elements 31 of the antenna member 30 may be easily and quickly attached or mounted or secured to the substrate 10 with the connecting elements 34, and with a greatly decreased manufacturing working or assembling time, and with a greatly decreased man power, and thus with a greatly decreased manufacturing cost. It is preferable, but not necessarily that the number of the antenna elements 31 of the antenna member 30 is equal to the number of the compartments 11 of the substrate 10, and it is preferable that the antenna elements 31 of the antenna member 30 are aligned with the compartments 11 of the substrate 10 and disposed or arranged above the compartments 11 of the substrate 10.

Accordingly, the array antenna device in accordance with the present invention includes a number of antenna members arranged to be easily and quickly attached or mounted or secured to the supporting base board and arranged for allowing the array antenna device to be easily and quickly assembled and manufactured by the workers and for decreasing the manufacturing cost for the array antenna device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An array antenna device comprising:
a substrate, an antenna member including a plurality of antenna elements, and including a plurality of connecting lines connected between said antenna elements for forming an integral structure, and
a plurality of connecting elements coupling and securing said antenna member to said substrate, for forming a spacing gap between said antenna member and said substrate.

2. The array antenna device as claimed in claim 1, wherein said substrate includes a plurality of compartments formed therein and aligned with said antenna elements of said antenna member.

3. The array antenna device as claimed in claim 2, wherein said substrate includes a plurality of casings having said compartments formed in said casings.

4. The array antenna device as claimed in claim 1, wherein said antenna member includes a feed connected to a feed wire, and said feed wire is coupled to said substrate.

5. The array antenna device as claimed in claim 1, wherein said connecting elements are made of electrically conductive materials.

6. The array antenna device as claimed in claim 1, wherein said connecting elements are made of dielectric materials.
